(19) United States
(12) Patent Application Publication
(10) Pub. No.: US 2026/0363221 A1
(43) Pub. Date: Nov. 19, 2026

(54) A HARVESTING UNIT, SYSTEM AND METHOD FOR BENTHIC MARINE ORGANISMS

(71) Applicant: Ava Ocean Technology AS, Ålesund (NO)

(72) Inventor: Terje STOKKEVÅG, Ulsteinvik (NO)

(21) Appl. No.: 19/130,865

(22) PCT Filed: Nov. 17, 2023
(86) PCT No.: PCT/NO2023/060098

§ 371 Date: May 16, 2025

(30) Foreign Application Priority Data
Nov. 18, 2022 (NO) 20221242

(51) Int. Cl. A01K 80/00

(52) U.S. Cl. CPC A01K 80/00

(57) ABSTRACT

The invention relates to a harvesting system and method for benthic marine organisms, the harvesting system comprises at least one suction and pumping device comprising, a pump comprising an inlet and an outlet, a motor attached to, and adapted to drive, the pump, a rigid inlet tube attached to the inlet of the pump and comprising a suction nozzle and a frame adapted to pivotally support the at least one suction and pumping device.

### TECHNICAL FIELD

Embodiments herein relate to a harvesting unit for benthic marine organisms. Embodiments herein further relate to system comprising one or more harvesting units and a method for use of the unit and system.

### BACKGROUND

Benthic marine organisms, such as the scallops, sea anemones, sponges, corals, sea stars, sea urchins, worms, bivalves, crabs, or shellfish are animal that lives in or on the sea floor, and has become a valuable source. However, fishing for benthic marine organisms is carried out on a very modest scale throughout. This is primarily due to the fact that to date no suitable method has been found for harvesting marine organisms from the seabed. From 1986 to 1992 some large-scale fishing of Iceland scallops was carried out in Norway, comprising trawling along the seabed. This turned out to be a highly lucrative and profitable method of fishing. At the same time, it was found that the fishing method of trawling along the seabed was both highly inefficient and non-sustainable for the environment and the stocks. Shellfish dredging taxes the fishing grounds in question 100%. This harvesting method was terminated and declared illegal by the authorities in the early 1990s. Since then, no one has found a technological solution for sustainable large-scale harvesting of benthic marine organisms, as there are no suitable method that is both gentle to the organisms and the environment for harvesting the organisms on the bottom of the sea floor.

Today there is no solution for large-scale fishing of bottom-dwelling marine organisms. They are fished in small quantities through diving. This is ineffective, relatively costly and seasonal. In addition, it entails a potential for accidents owing to limited light, the cold and weather conditions. The only known technology for fishing bottom-dwelling marine organisms is bottom trawling. Bottom dredging for bottom-dwelling marine organisms is a poor solution since the dredging is done at the expense of the seabed environment. As mentioned above, this method is prohibited in Norway. As a solution, trawling is also far less efficient than the proposed solution. When trawling, perhaps as much 95% of that brought on board will be rocks, sand and bycatch. In addition, as much as about 70% of the catch will be damaged by trawling. It is also a method that is not sustainable for the marine environment as the seabed is scraped and damaged during fishing.

It is therefore a need for gentle harvesting unit, system and method for bottom-dwelling marine organisms that gently collets and transports the catch. It is a further need for a harvesting unit that follows the seabed without damaging it.

The invention is a solution to the aforementioned problems and is a gentle harvesting method and system both for the environment and for marine ecosystems. Species that are not to be caught are carefully sorted out. In addition, small organises will also be sorted out and allowed to continue to grow and contribute to maintaining the stock in a much better way than by trawling where the entire catch is brought aboard the vessel.

Patent publication JPH0643A describes a system for gathering shellfish from the sea bottom where the shellfish are first loosened from the bottom and then brought onto the deck of a vessel. A pipe, a nozzle and an inlet are fixed to a sledge-like assembly with a shoe comprising support stays. Shellfish that are on the seabed are loosened therefrom with the aid of high-pressure fluid, sucked up with the aid of a negative pressure generated by blades/vanes and brought to the surface in a fluid flow and then carried further via a lift pump.

Patent publication JPS5486597U describes a system where the shellfish are loosened from the seabed with the aid of a plurality of high-pressure nozzles. The shellfish are then sucked through a hose connection up to the sea surface and finally they are stored in a container on the vessel. The system consists of a sledge-like object with shoe, struts and a plurality of nozzles. The nozzles are supplied with fluid from a pump on the vessel via a hose. The collecting system on the seabed comprises a sledge designed to be dragged along the seabed with the aid of a towrope that is attached to the vessel.

Norwegian Patent NO333031 describes a device for collecting objects from the seabed using a ROV, or a hydraulic arm controlled from a surface vessel, where the device is installed on a ROV/hydraulic arm and consists of a nozzle, a suction chamber, an underpressure pump and an exhaust system, and uses suction to collect objects, and has a nozzle specially constructed for collecting a specific object.

GB2332848A describes an apparatus for harvesting shellfish on the seabed, which comprises a cage and a blade mounted on a frame that is adapted to be towed along the seabed. A feed pipe discharges fluid under high pressure adjacent to the blade to produce turbulence and a suction pipe removes material collected in the cage. The blade is adapted to free the catch from the seabed and is adjustable so that the angle and depth of penetration of the blade can be altered. The suction pipe preferably operates as an air lift pump.

GB1207906A teaches a suction dredging apparatus for the harvesting of molluscs and the like. The apparatus includes dredge means for collecting molluscs from the seafloor, collecting means that define channels of travel for molluscs, means for supplying high-pressure gas to guiding means at a point adjacent the dredge means whereby the buoyancy and velocity of the said gas induce a movement of the molluscs through the said channels.

GB1156547A teaches a marine dredge that takes molluscs up from the seafloor and transports them continuously to a surface vessel that tows the dredge.

US Patent Application US2003/172557A1 teaches an apparatus for harvesting shellfish from the seabed, comprising a source of pressurised water, at least one water jet arranged to receive water from the water source and direct it at shellfish-containing sediments, sorting plates for receiving the shellfish-containing sediments excavated by the at least one water jet and separating the shellfish from the sediments, a collection chamber for receiving the separated shellfish and dual lifting compartments, one of which is connected to the pressurised water source for lifting shellfish from the collection chamber and entraining the shellfish for transport to the surface, and the other of which is arranged to receive pressurised air for increasing the transport speed and lifting power whilst cushioning the shellfish as they are transported to the surface.

U.S. Pat. No. 2,204,584A teaches an apparatus that removes material such as oysters, shellfish etc. from the seabed, consisting of hydraulic dredging that brings a water flow into a nozzle and through a vertical passage whilst the nozzle is directed towards the seabed in order to remove the said material, this being suspended in and brought up with the water flow through the passage and up to, e.g., a surface vessel where it is collected and stored.

U.S. Pat. No. 3,783,536A teaches an apparatus that collects biological or geological material from the seafloor, which comprises a surface vessel, a downwardly depending conduit, a second conduit arranged in the first downwardly depending conduit, and a first and second endless belt conveyor disposed within the said conduit, a suction pump arranged on the surface vessel, and the upper part of the second conduit is connected to the suction pump inlet.

FR2735329A describes fishing gear consisting of an underwater frame that is attached to a fishing vessel that drags it along the seabed. The underwater frame carries a guide and a suction head that is positioned towards the forward part of the frame and creates a vacuum that carries material from the seabed onto a platform located at a certain fixed distance from the forward frame part. A carrier above and in front of the suction head forms a support for the upper edge of the net and enables the living organisms that pass over the suction head to be caught. A transport duct transfers the living organisms that are caught by both apparatus from the underwater frame and up to the surface vessel.

Further known solutions are disclosed in the documents WO 2003088742 A1, U.S. Pat. No. 7,036,295B1, CN206821751U, WO2018231064A1 A common feature of the collecting gear that pulls or drags a frame with suction means along the seabed is that a tube between a nozzle and a pump, such as on a suspended frame, or on a surface vessel, bends and changes direction. This causes unnecessary stress and possible harm to the catch when it travels through the tubing. This is especially critical in the areas close to the inlet and outlet of a pump.

The drawbacks of the prior art relates to the suction nozzles and pumps and the path between them. To be able to follow the ocean floor, the prior art discloses suction nozzles that can be lifted or lowered in relation to the floor. This causes the tube between the suction nozzles and pumps to bend, which causes unfavorable conditions for the living marine organisms that are being sucked up from the ocean floor and discarded into a cage.

The present invention is thus intended to at least solve two problems: How to prevent damage to the catch during harvesting and how to prevent damage to the seabed during harvestings.

### SUMMARY OF THE INVETION

According to an embodiment, this is provided a harvesting system for benthic marine organisms, the harvesting system comprises:
at least one suction and pumping device comprising:
a pump comprising an inlet and an outlet,
a motor attached to, and adapted to drive, the pump,
a rigid inlet tube attached to the inlet of the pump and comprising a suction nozzle,
a frame adapted to pivotally support the at least one suction and pumping device.
   The suction and pumping device is pivotably connected to the frame, or parts thereof, via a corresponding pivot members, wherein the at least one suction and pumping device and the inlet tube are pivotable around said pivot member. Since the pump, motor and rigid inlet tube are all pivotable around the hinge, the suction nozzle can move in relation to the frame without altering the path of travel for any catch that travels through the assembly.

According to some embodiments, the suction and pumping device is a centrifugal pump operationally connected to an electromotor adapted to drive the centrifugal pump, wherein the centrifugal pump has an axis of rotation aligning with at least a part of the inlet tube and the electromotor.

According to some embodiments, the suction nozzle is rigidly attached to the inlet tube.

According to some embodiments, the suction nozzle is movably connected to the inlet tube via a joint arrangement.

According to some embodiments, the joint arrangement is a joint, a ball joint, a rotational flange joint or a deflectable intermediate member.

According to some embodiments, the nozzle comprises a leading rubber sealing portion and a trailing rubber sealing portion, the leading rubber sealing portion and the trailing rubber sealing portion each comprises a bracing in one end connected to the nozzle or inlet tube.

According to some embodiments, an actuator device is in one end attached to the frame or parts thereof, and in another rend attached to the rigid inlet tube, pump or motor adapted to rotate the suction and pumping device around the pivot member.

According to some embodiments, the actuator device is a wince or linear actuator.

According to some embodiments, a holder frame is fixed to, holds and supports the suction and pumping device and pivotally connects the suction and pumping device to the frame via the pivot members.

According to some embodiments, the frame comprises a sensor unit and wherein the inlet tube, pump or motor comprises a corresponding sensor unit arranged to register if the sensor unit and corresponding sensor unit are in contact or not.

According to some embodiments, the harvesting system further comprises a collecting unit, wherein the collecting unit at least comprises a screening device situated between outlet and a collecting part of the collecting unit.

According to some embodiments, the frame comprises a main frame structure with a forward portion and a reward portion, wherein two pivot members are situated on a forward protruding portion and the motor of the suction and pumping device is situated at least partly further forward than the two pivot members and the suction nozzle is at least protruding the frame in the rewards direction.

According to some embodiments, the frame comprises at least one thruster adapted to steer the direction of the harvesting system whilst being towed.

According to some embodiments, the system comprises multiple suction and pumping devices supported in a common frame, each suction and pumping devices comprises corresponding inlet tubes and suction nozzles.

According to some embodiments, each suction and pumping devices comprises corresponding collecting units.

According to some embodiments, the invention relates to an harvesting unit comprising a suction and pumping device comprising: an inlet and an outlet, wherein an inlet of the pump is attached to a rigid inlet tube comprising a suction nozzle directed towards the seabed, wherein the harvesting unit is adapted to be pivotally support to a frame by at least one pivot member, and wherein suction and pumping device comprises a pump and motor for driving the pump.

The invention also relates to an method for harvesting benthic marine organisms from a seabed, wherein the method comprises the following steps:
lowering a harvesting system in accordance with any one of the claims 1-16 from a vessel via a towing and launching system down to the seabed; and
angle the nozzle 8 and inlet tube 7 towards the seabed; and
sucking up benthic marine organisms via one or more suction nozzles directed towards the seabed using one or more suction and pumping device ; and
separating catch from bycatch and foreign bodies using a screening device; and
passing the shellfish to a collecting unit; and
towing the harvesting unit along the seabed by means of the vessel; and
controlling and adjusting the position of the suction nozzles by means of rotating each suction and pumping device around the pivot point.

According to some embodiments, wherein the method comprising the step of either passively or actively adjusting the position of the suction nozzles.

### BRIEF DESCRIPTION OF THE DRAWINGS

The various aspects of embodiments herein, including its particular features and advantages, will be readily understood from the following detailed description and the accompanying drawings, in which:

FIG. 1 illustrates a harvesting system seen from the side.

FIG. 2 illustrates a sectional view of a harvesting system.

FIG. 3 illustrates a harvesting system seen from the front.

FIG. 4 illustrates a harvesting system seen from above.

FIG. 5 illustrates a harvesting system seen from above.

FIG. 6 illustrates a harvesting system seen from above.

FIGS. 7a and 7b illustrates a harvesting system in two different positions.

FIG. 8 illustrates a close up view of the suction nozzle.

FIG. 9 illustrates a harvesting device.

### DETAILED DESCRIPTION

Embodiments herein will now be described more fully with reference to the accompanying drawings, in which example embodiments are shown. However, this application should not be construed as limited to the embodiments set forth herein. Disclosed features of example embodiments may be combined as readily understood by one of ordinary skill in the art to which this application belongs. Like numbers refer to like elements throughout. Directions such as front, back, side, above and below is described with reference to the figure and are normally to be understood with the unit and system in normal use being towed forward.

Well-known functions or constructions will not necessarily be described in detail for brevity and/or clarity.

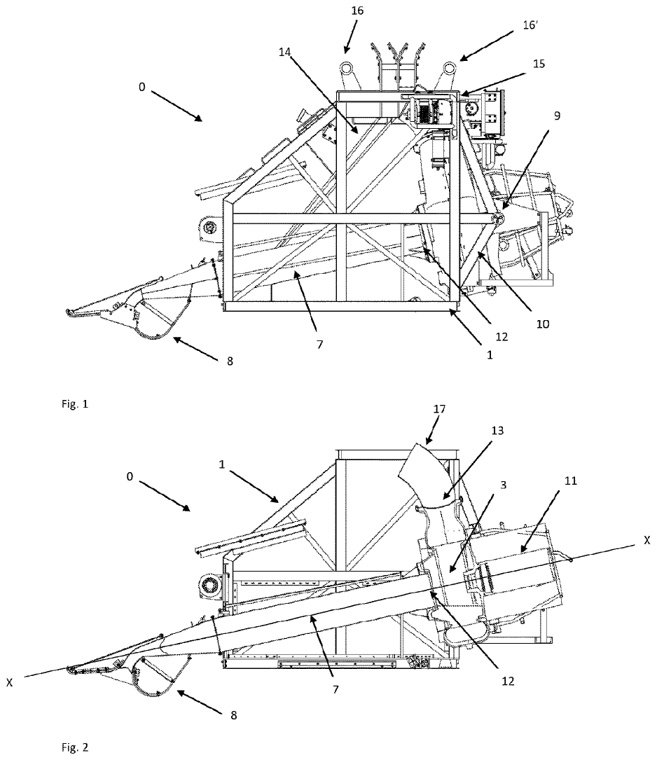

In FIG. 1, an embodiment of the invention is illustrated with a frame structure 1 adapted for being towed in a body of water by a vessel (not shown) at a depth just above the seabed. The frame 1 can be suspended and towed by the attachment members 16, wherein ropes or towlines can connect the harvesting system to the vessel. Pivotally attached to the frame 1 is a suction and pumping device 3, 11 comprising a pump 3 with a motor 11 adapted to drive the pump 3. The harvesting system can be deployed, and retrieved by a vessel with a towing and launching system. Once deployed the harvesting system can be towed at a predetermined distance over the seabed to harvest benthic marine organisms by providing suctions, such as, but not limited to, clams, worms, oysters, shrimp-like crustaceans, and mussels. The pump 3 can be a centrifugal pump and the motor 11 can be a watertight electromotor or a hydraulically driven motor.

The frame 1 is adapted to pivotally support the at least one suction and pumping device 3, 11, whereby the suction and pumping device 3, 11 is rotably connected to the frame 1 via a corresponding hinges, such as pivot members 9 attached to the frame 1 or parts thereof. Thus, the at least one suction and pumping device 3, 11 and the inlet tube 7 are pivotable around the pivot member 9. With this configuration, the entire suction assembly (nozzle 8, pipe 7, pump 3 and motor 11) is rotated around the hinges 9 to constitute a suction path for the catch that does not change depending on the angle the inlet tube 7 has to the ground or a horizontal plane. With the weight of the motor 11 on one side of the pivot member 9 and the pump 3, nozzle 8 and pipe 7 on the other, the suction assembly is preferably balanced so that the nozzle 8 can follow the alterations of the seabed in a passive manner. Depending on the weight of the components, the motor can be on a forward side of the pivot member alone, or the motor and pump can be on a forward side of the hinge, or the motor, pump and a part of the inlet tube 7 can be situated on a forward side of the hinge. Preferably, the momentum of the nozzle-side will be greater around the pivot member 9 than the motor-side, such that if the nozzle 8 is forced upwards, for instance in relation to the frame 1 by an elevation of the seabed, the nozzle 8 will lower itself once the upward force ceases. In that way, the nozzle 8 can follow the shape and curvature of the seabed without exerting a damaging force to the seabed. In case of an encounter with a larger obstacles, such as a rock or the like, the nozzle 8 will be pushed upwards without damaging the nozzle 8 or inlet tube 7. With this configuration, the suction nozzle 8 can be moved higher or lowered in relation to the frame 1 and collection unit 2 by rotation around the hinge 9. During rotation, or from one angle of rotation to another, the path that any marine organisms will travel, from the inlet tube 7 to the pump outlet 13, will stay unchanged. The only change will be where in the collection basket 2 the outlet 13 will be positioned.

As seen in FIG. 2, the pump 3 comprises an inlet 12 and an outlet 13, wherein the inlet 12 of the pump is attached to a rigid inlet tube 7 comprising a suction nozzle 8 directed towards the seabed. The inlet 12 is aligned along a direction corresponding to the axis X-X, which is the axis of rotation for the pump 3 and electromotor 11, and the outlet 13 is directed in a direction perpendicular to the axis X-X. In the illustrated embodiment, a directional guide 17 is situated on the outlet 13 adapted to change the direction of discharge from the pump 3. The directional guide 17 may be a bent pipe, a cone, or the like. FIG. 2 further illustrates that the pump 3 has an axis of rotation X aligning with at least a part of the inlet tube 7.

In another embodiment, the harvesting unit or the system, may comprise hydraulic or electric actuator device 14 in one end attached to the frame 1 or parts thereof, and in another rend attached to the rigid inlet tube 7, in order for the inlet tube 7 to be lifted and/or lowered in relation to the frame 1 and seabed. Thus, the entire suction assembly (nozzle 8, pipe 7, pump 3 and motor 11) can be actuated by the actuator 14 to be rotated around the hinges 9. Said actuator device 14 can be a winch 14 attached to the frame 1 with a wire from the winch in one end attached to the inlet tube 7, or parts thereof as illustrated in FIG. 8. The actuator 14 can also be an linear actuator, wherein one end is attached to the frame and another is attached to a part of the suction assembly (nozzle 8, pipe 7, pump 3 and motor 11). The actuator can be used for active compensation of the nozzles 8 distance to the seabed, such that the nozzle 8 can follow the curvature of the seabed while the frame is towed at a constant depth below a vessel. Thus, the invention may comprise a system for either active or passive compensations of the angle and rotation of the pipe 7, and thus the distance from a lower part of the frame 1 to the nozzles 8. Both active and passive compensation can be used counteract heaving movement of the vessel or change in depth and the curvature of the seabed. In the passive configuration, the nozzle 8 follows the seabed by the weight of the nozzles 8, and will follow the curvature of the seabed as its being towed along. In an active configuration, a camera or senor located on the frame can record data rearing the seabed in front of or under the harvesting unit, wherein the recorded data can be processed by a processing device which can control the actuator 14 to lower or lift the nozzle 8 (rotate the suction assembly (nozzle 8, pipe 7, pump 3 and motor 11) around pivot member 9) in response to the changing seabed or the heave of the vessel. in an embodiment of the invention, the suction nozzle 8 can be arranged to be raised and lowered relative to the frame 1 with the aid of hydraulic or electric actuators 14. It is also possible to use a pulley/wire/motor arrangement 14 for this purpose. This simplifies the way in which each individual nozzle 8 and inlet tube 7 can be adjusted and positioned according to the characteristics of the seabed topology. This will be achieved with the aid of cameras or sensors that are arranged at different points on the harvesting unit and which provide feedback to a control system that is connected to the suction nozzle actuators.

In another embodiment the harvesting system can be provided with power from a vessel adapted to tow the harvesting system, such as providing power to the motor and/or control signals and power to operate, control and steer and activate the motor, actuators and possibly any thrusters 15.

Situations may arise where an operator or user needs to know the position of the suction assembly (nozzle 8, pipe 7, pump 3 and motor 11) in relation to the frame 1. Thus the invention may comprise a sensor unit 191 on the frame 1 and a corresponding sensor unit 192 on the nozzle 8, pipe 7, pump 3 or motor 11 arranged to register if the sensor unit 191 and corresponding sensor unit 192 are in contact or not. A communication device can provide communication between the vessel or an control element on the vessel.

To collect the catch that is expelled from the outlet 13 of the pump 3, the harvest system may comprise a collecting unit 2, wherein the collecting unit 2 at least comprises a screening device 20 situated between outlet 13 and a collection part 21 of the collecting unit 2. The screening device 20 is adapted to separate catch from bycatch. This can be different sizes of the same species, or to separate different species. Bycatch can, for example, consist of rocks, seaweed, dead vegetation and unwanted species. Preferably, each harvesting unit, if multiple units are suspended in a frame, will each comprise a collecting unit 2, such that if multiple units are used in a system, the system can comprise a collecting unit 2 for each harvesting unit. In an embodiment of the harvesting system the collecting unit 2 is provided with wire mesh, grating or netting in its walls and bottom. The collecting unit 2 can be configured in many different ways, such as, for example, a box with drainage, a box with slots, perforations, netting, wire mesh, grating or solid walls. The advantage of these devices is that they can carry out a final sorting of the catch and discard minor contaminants that were not detected in the earlier screening device 20. The screening device 20 will, in principle, be able to use size, specific gravity and gravitational forces, optical imaging and image analysis, mechanical sorting, ultrasound analysis (Doppler, acoustic impedance, size measurement) or utilisation of multiple ultrasound transmitters in order to sort undesired objects from desired catch.

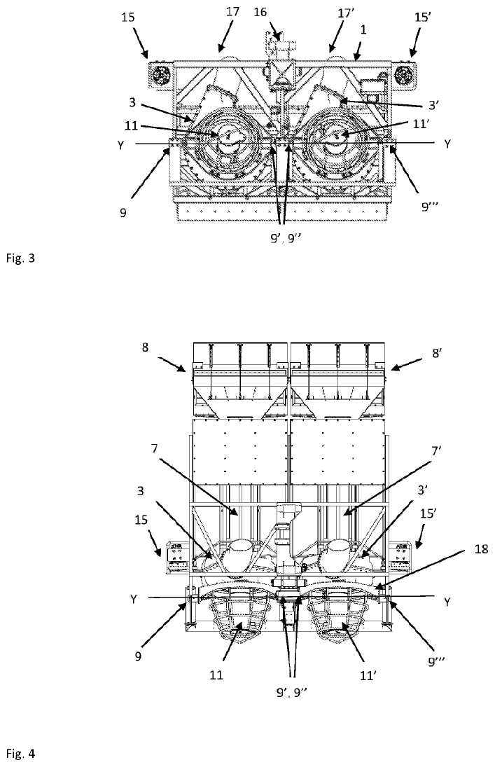

As seen in FIG. 1, the frame 1 may comprises a main frame structure with a forward portion and a reward portion, wherein two hinges 9, 9′ are situated on either side of forward protruding 10 of the frame and the electromotor 11 of the suction and pumping device 3, 11 is situated at least partly further forward than the two hinges 9 and the suction nozzle 8 is at least protruding the frame 1 in the rewards direction. The frame 1 can be a frame arrangement adapted to structurally support one or more harvesting units with the collecting unit(s) 2, in addition to support features such as one or more cameras and sensors, thruster's 15 and directional equipment, actuators 14 and attachments means 16 for towlines. As seen on FIG. 3, the system the frame 1 may comprises at least one thruster 15 adapted to steer the orientation of the unit or system in relation to the towing direction. FIGS. 3 and 4 illustrates an embodiment wherein two thrusters 15, 15′ are arranged on the frame 1. The invention further relates to a system as seen in FIGS. 3, 4, 5 and 5 wherein multiple harvesting units are situated and suspended in a common frame 1.

FIG. 3 illustrates an alternative embodiment of the invention, wherein a harvesting system is seen from the front, wherein two sets of suction and pumping devices 3, 11, 3′, 11′, each with a corresponding inlet tube 7 and suction nozzle 8, are rotablyt attached and suspended in a frame 1. Each suction and pumping devices 3, 11, 3′, 11′ are each suspended by two pivot members 9, 9′, 9″, 9″ respectfully situated on either side of the of suction and pumping devices 3, 11, 3′, 11′, wherein the rotational axis Y-Y of the pivot members 9, 9′, 9″, 9″ perpendicular intersects the axis X-X.

FIG. 4 illustrates an alternative embodiment of the invention, wherein a harvesting system is seen from above, wherein two sets of suction and pumping devices 3, 11, 3′, 11′, each with a corresponding inlet tube 7 and suction nozzle 8, are rotablyt attached and suspended in a frame 1. Each suction and pumping devices 3, 11, 3′, 11′ are each suspended by two pivot members 9, 9′, 9″, 9″ respectfully situated on either side of the of suction and pumping devices 3, 11, 3′, 11′, wherein the rotational axis Y-Y of the pivot members 9, 9′, 9″, 9″ perpendicular intersects the axis X-X.

FIG. 5 illustrates an alternative embodiment of the invention, wherein a harvesting unit is seen from the front, wherein three sets of suction and pumping devices 3, 11, 3′, 11′, 3″, 11″, each with a corresponding inlet tube 7 and suction nozzle 8, are rotablyt attached and suspended in a frame 1. Each suction and pumping devices 3, 11, 3′, 11′, 3″, 11″, are each suspended by two pivot members 9, 9 respectfully situated on either side of the of suction and pumping devices 3, 11, 3′, 11′, 3″, 11″.

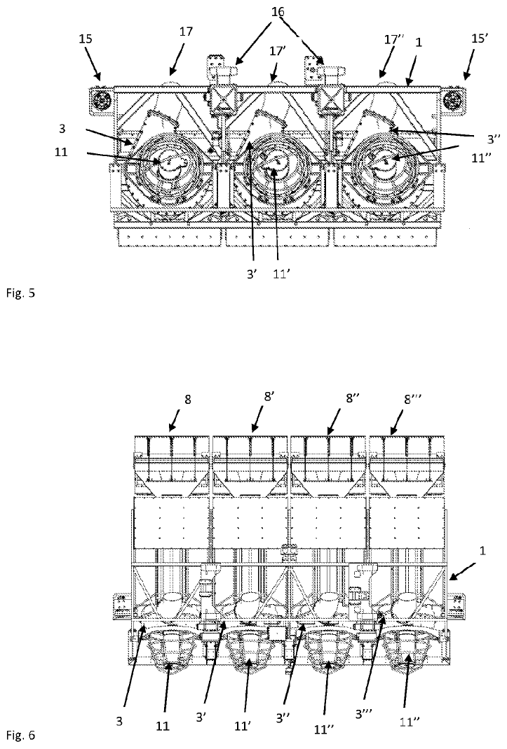

FIG. 6 illustrates an alternative embodiment of the invention, wherein a harvesting unit is seen from above, wherein four sets of suction and pumping devices 3, 11, 3′, 11′, 3″, 11″, 3″′, 11′″ each with a corresponding inlet tube 7 and suction nozzle 8, are rotablyt attached and suspended in a frame 1. Although the invention is illustrated with one, two, three and four sets of suction and pumping devices 3, 11 with corresponding inlet tube 7 and suction nozzle 8 suspended in one frame 1, it should be understood that any number of suction and pumping devices might be fitted in a frame to cover a larger area of the seabed. This will in practice have no limits where weight is concerned. If there is a need for buoyancy due to the weight of the harvesting systems, the system can be equipped with buoyancy elements. Since each unit is a self-sufficient unit, the harvesting unit will be capable of being modularly configurable according to the bottom conditions, production capacity and the capacity of the vessel.

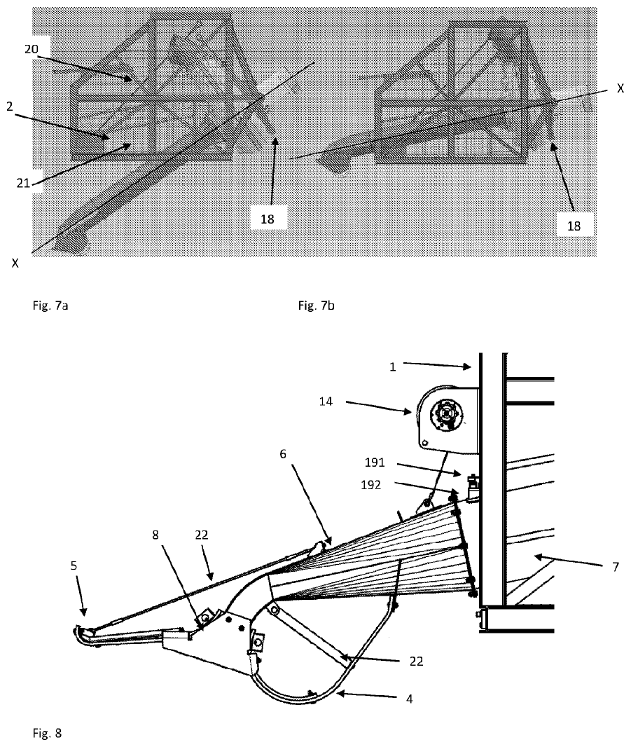

As seen in FIGS. 7a and 7b (and FIG. 4), the suction and pumping devices 3, 11 can be suspended or fastened to a holder frame 18, that at least partly encompasses at least a part of the suction and pumping devices 3, 11, for instance in a circular manner. The holder frame can be fixedly attached to the suction and pumping devices 3, 11 and may comprise a first part of the pivot member 9. In this configuration, the frame 1 may comprise a corresponding second part of the pivot member, such that the two frames 1, 18 are arranged to be pivotable in relation. As seen in FIGS. 3 and 4, each suction and pumping devices 3, 11 can be suspended by two pivot members 9, one on respective sides of the pumping devices 3, 11.

FIGS. 7a and 7b illustrates an embodiment of the harvesting system in two different positions. In FIG. 7a the axis X-X, which is the axis of rotation for the pump 3 and electromotor 11 and which follows a center of the inlet tube 7, is situated at a first angle to the horizontal plane. In this position the nozzle 8 is lowered to the seafloor. In FIG. 7b, the axis X-X has a second angle to a horizontal plane, smaller than the first angle, and the nozzle 8 and inlet tube 7 is lifted, with reference to the position in FIG. 7a, into a position wherein it sits partly in between the frame 1. The frame 1 and collecting unit 2 may thus comprise a space open up towards the seabed, such that the lifting of the nozzle 8 and inlet tube 7 can at least partly sit between parts of the frame 1 and parts of the collecting unit 2. Said space can be a void or open tunnel arrangement on the underside of the frame 1 and collecting unit 2. For instance, the frame can and corresponding collecting unit 2 may comprise a substantially upside down U shape.

FIG. 8 illustrates a close up view of the suction nozzle 8. The suction nozzle 8 may be fixedly and rigidly attached or integrated with inlet tube 7. However, there may be situations where the need to fine tune the nozzle 8 is present, such as if the seabed has minute alterations or where the seabed fauna is exceptionally delicate. In these environments, the invention may comprise an articulated nozzle 8. Thus, the invention may in an embodiment comprise comprises a joint arrangement 6, whereby the suction nozzle 8 is movably attached to the inlet tube 7. The joint arrangement 6 may comprise an actuator adapted to lift or lower the suction nozzle 8 in relation to the inlet tube 7. The joint can be used to absorb hits and bumps from the surface to make sure abrupt forces are not translated to the pump and/or motor. The joint arrangement 6 can be a deflectable joint in a tube, a ball joint, a rotational flange joint or a deflectable intermediate member, such as a rubberised section or the like. In an alternative embodiment, the joint arrangement 6 can comprise an actuator adapted to tilt the suction nozzle 8 in relation to the inlet tube 7. As illustrated in FIG. 8, the nozzle can comprise a leading rubber seal 4 and a trailing rubber seal 5 situated on a foremost and backmost portion of the opening of the suction nozzle 8 to facilitate a better suction effect. Furthermore, the suction nozzle 8 may comprise stiffeners 22 between parts of the suction nozzle 8, joint arrangement 6 or inlet tube 7 and the leading rubber seal 4 and a trailing rubber seal 5.

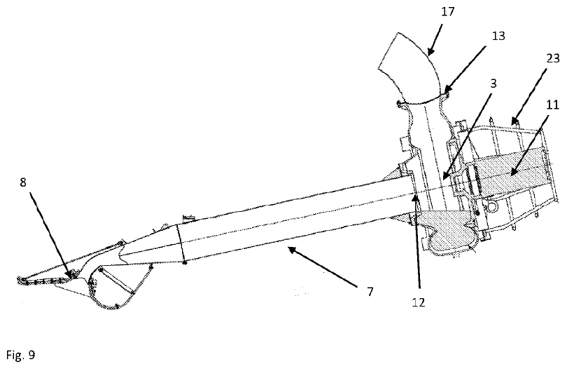

FIG. 9 illustrates a harvesting unit comprising a suction and pumping device 3, 11 comprising an inlet 12 and an outlet 13, wherein the inlet 12 of the pump is attached to a rigid inlet tube 7 comprising a suction nozzle 8 adapted to be directed towards the seabed, wherein the harvesting unit is adapted to be pivotally support to a frame 1 by at least one pivot member 9. The harvesting unit can further comprise an protective cage 23 enclosing motor 11 and/or a holder frame 18 attached to and enclosing the suction and pumping device 3, 11, or parts thereof, wherein the holder frame 18 is adapted to be pivotally coupled to a frame 1.

In an embodiment of the invention, the harvesting unit comprises vertical and/or horizontal thrusters 15 that are designed to finely adjust or support the positioning of the harvesting unit relative to the seabed. It is advantageous for the harvesting system if the vertical or horizontal thrusters 15 are able to independently position the harvesting unit in, respectively, the x-axis, the y-axis and/or the z-axis, depending on the characteristics of the seabed. This will render the harvesting activity more efficient.

In an embodiment of the invention, there will be a control and monitoring system which can be adapted to adjust at least one or more of the following components: the uction and pumping device 3, 11, the actuator(s) 14, the thrusters 15. The harvesting system can advantageously be managed, monitored and controlled in its entirety from a vessel. The harvesting efficiency of the harvesting unit will be affected by two main parameters: the individual density of the shellfish and the characteristics of the seabed. To obtain optimal harvesting efficiency, it is necessary to be able to chart the catch in the area where harvesting is to take place ahead of the fishing operation. By using one or more cameras and light sources that may be mounted on the harvesting unit, the operator or control system will have an advance picture of the nature of the seabed topography and the location of concentrations of shellfish on the seabed. Here, image recognition can be used, where sensors are mounted at different points on the harvesting unit and are able to scan the seafloor and the area from where shellfish are to be harvested, for example, 0 -50 metres further ahead (so-called predictive image analysis). Based on this gathered information, the operator or the control system can decide or predict (visually or via algorithms) which way or direction the harvesting system should move to maximise the harvesting. At the same time, this will allow the operator to see or receive information if the seabed consists of sensitive flora/coral that can be avoided in order to prevent needless negative impact on the environment. In the charting and harvesting phase, the control and monitoring system can process and register the coordinates of the harvesting unit during the operation (for example, via a GPS, tracker or other positioning device) such that it is stored thereby avoiding harvesting in the same place at a later time. Documentation of where the harvesting unit has been can also be a requirement set by the fishery authorities as a part of the harvesting concession and reporting.

The harvesting system can be used by first lowering the harvesting unit or system from a vessel via a towing and launching system down to the seabed, then angle the nozzle 8 and inlet tube 7 towards the seabed. By activating the motor and pump 3, 11, benthic marine organisms on the ocean floor will be sucking up via one or more suction nozzles 8 directed towards the seabed. The catch can then be separated from bycatch and foreign bodies using a screening device 20 and the benthic marine organisms will be passed to a collecting unit 2 supported by the frame 1. To cover unevenness of the seabed, the harvesting system is towed along joust above the seabed by means of the motion of the vessel and the suction nozzles 8 is controlled and adjusted by means of rotating each suction and pumping device(s) 3, 11 around the pivot point(s) 9. The position of the suction nozzles 8 can either be passively or actively adjusted.

### REFERENCE NUMERALS

1 Frame
2 Collecting unit
3 Pump
4 Leading rubber sealing portion
5 Trailing rubber sealing portion
6 Joint arrangement
7 Inlet tube
8 Suction nozzle
9 Pivot members
10. Protruding portion of the frame
11 Motor
12 Pump inlet
13 Pump outlet
14 Actuator device
15 Thruster
16 Attachment members for towlines
17 Directional guide of outlet
18 Holder frame
191 Sensor unit
192 Corresponding sensor unit
20 Screening device
21 Collecting part
22 Stiffeners
23 Cage

1.-17. (canceled)

18. A harvesting system for benthic marine organisms, the harvesting system comprises:
at least one suction and pumping device comprising:
a pump comprising an inlet and an outlet,
a motor attached to, and adapted to drive, the pump,
wherein the harvesting system is characterized by comprising a rigid inlet tube attached to the inlet of the pump and comprising a suction nozzle,
a frame adapted to pivotally support the at least one suction and pumping device, and wherein the suction and pumping device is pivotably connected to the frame, or parts thereof, via a corresponding pivot members, wherein the at least one suction and pumping device and the inlet tube are pivotable around said pivot member.

19. The harvesting system according to claim 18, wherein the suction and pumping device is a centrifugal pump operationally connected to an electromotor adapted to drive the centrifugal pump, wherein the centrifugal pump has an axis of rotation aligning with at least a part of the inlet tube and the electromotor.

20. The harvesting system according to claim 18, wherein the suction nozzle is rigidly attached to the inlet tube.

21. The harvesting system according to claim 18, wherein the suction nozzle is movably connected to the inlet tube wherein the movably connected comprises a joint arrangement.

22. The harvesting system according to claim 21, wherein the joint arrangement is a joint, a ball joint, a rotational flange joint or a deflectable intermediate member.

23. The harvesting system according to claim 18, wherein the nozzle comprises a leading rubber sealing portion and a trailing rubber sealing portion, the leading rubber sealing portion and the trailing rubber sealing portion each comprises a bracing in one end connected to the nozzle or inlet tube.

24. The harvesting system according to claim 18, wherein a actuator device is in one end attached to the frame or parts thereof, and in another rend attached to the rigid inlet tube, pump or motor adapted to rotate the suction and pumping device around the pivot member.

25. The harvesting system according to claim 24, wherein the a actuator device is a wince or linear actuator.

26. The harvesting system according to claim 18, wherein a holder frame holds and supports the suction and pumping device and pivotally connects the suction and pumping device to the frame.

27. The harvesting system according to claim 18, wherein the frame comprises a sensor unit and wherein the inlet tube, pump or motor comprises a corresponding sensor unit arranged to register if the sensor unit and corresponding sensor unit are in contact or not.

28. The harvesting system according to claim 18, wherein harvesting system further comprises a collecting unit, wherein the collecting unit at least comprises a screening device situated between outlet and a collecting part adapted to collect catch.

29. The harvesting system according to claim 18, wherein the frame comprises a main frame structure with a forward portion and a reward portion, wherein two pivot members are situated on a forward protruding portion and the motor of suction and pumping device is situated at least partly further forward than the two pivot members and the suction nozzle is at least protruding the frame in the rewards direction.

30. The harvesting system according to claim 18, wherein the frame comprises at least one thruster adapted to steer the direction of the harvesting system whilst being towed.

31. The harvesting system according to claim 18, wherein the system comprises multiple suction and pumping devices supported in a common frame, each suction and pumping devices comprises corresponding inlet tubes and suction nozzles.

32. A harvesting unit comprising a suction and pumping device comprising:
an inlet and an outlet, wherein an inlet of the pump is attached to a rigid inlet tube comprising a suction nozzle directed towards the seabed, wherein the harvesting unit is adapted to be pivotally support to a frame by at least one pivot member.

33. A method for harvesting benthic marine organisms from a seabed, characterised by the following steps:
lowering a harvesting system in accordance with claim 18 from a vessel via a towing and launching system down to the seabed; and
angle the nozzle and inlet tube towards the seabed; and
sucking up benthic marine organisms via one or more suction nozzles directed towards the seabed using one or more suction and pumping device(s); and
separating catch from bycatch and foreign bodies using a screening device; and
passing the shellfish to a collecting unit; and
towing the harvesting unit along the seabed by means of the vessel; and
controlling and adjusting the position of the suction nozzles by means of rotating each suction and pumping device(s) around the pivot point(s).

34. The method according to claim 33, wherein the method comprising the step of either passively or actively adjusting the position of the suction nozzles.
